(19) United States
(12) Patent Application Publication
(10) Pub. No.: US 2006/0047734 A1
(43) Pub. Date: Mar. 2, 2006

(54) Fast conversion of integer to float using table lookup

(75) Inventors: Robert James Blainey, Newmarket (CA); Shimin Cui, Toronto (CA); Mark Peter Mendell, Toronto (CA); Steven Wayne White, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/929,192

(22) Filed: Aug. 30, 2004

(51) Int. Cl. G06F 7/00

(52) U.S. Cl. 708/204

(57) ABSTRACT

Method, system and computer program product for converting integers to floating point values in a data processing system. The method utilizes data flow analysis and control flow analysis to recognize that a particular integer that is to be converted contains only a limited range of values. Knowledge of this limited range is used to establish a table of floating point values indexed by the integer value. By using the table of floating point values, conversion of an integer to a floating point value can be performed faster and with reduced memory traffic.

### BACKGROUND OF THE INVENTION

1. Technical Field

The present invention relates generally to the data processing field and, more particularly, to a method, system and computer program product for converting an integer to a floating point value in a data processing system.

2. Description of Related Art

Floating point values are commonly used to represent real numbers on a computer. Many modern computer architectures, however, tend to be very slow when converting between integers and floating point values. For example, in data processing systems having a PowerPC architecture, conversion is accomplished by storing an integer value into a known pattern in memory, and then loading the result back as a floating point value. This conversion technique, referred to as a store/reload conversion technique, can be very time consuming as it involves memory traffic, and stores into only part of reloaded memory. With the PowerPC system, however, there is no faster way to convert a general integer to a floating point value.

Other computer architectures have direct conversion instructions, but may be costly in terms of chip area or time required to execute.

It would, accordingly, be advantageous to provide a mechanism, in a data processing system, for converting an integer to a floating point value that permits a reduction in both processing time and memory traffic.

### SUMMARY OF THE INVENTION

The present invention provides a method, system and computer program product for converting an integer to a floating point value in a data processing system. The method utilizes data flow analysis and control flow analysis to recognize that a particular integer that is to be converted contains only a limited range of values. Knowledge of this limited range is used to establish a table of floating point values indexed by the integer value. By using the table of floating point values, conversion of an integer to a floating point value can be performed faster and with reduced memory traffic.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a data processing system in which the present invention may be implemented;

FIG. 2 is a block diagram of a data processing system in which the present invention may be implemented; and

FIG. 3 is a flowchart that illustrates a method for converting integers to floating point values in accordance with a preferred embodiment of the present invention.

### DETAILED DESCRIPTION OF THE PREFERRED EMBODIMENT

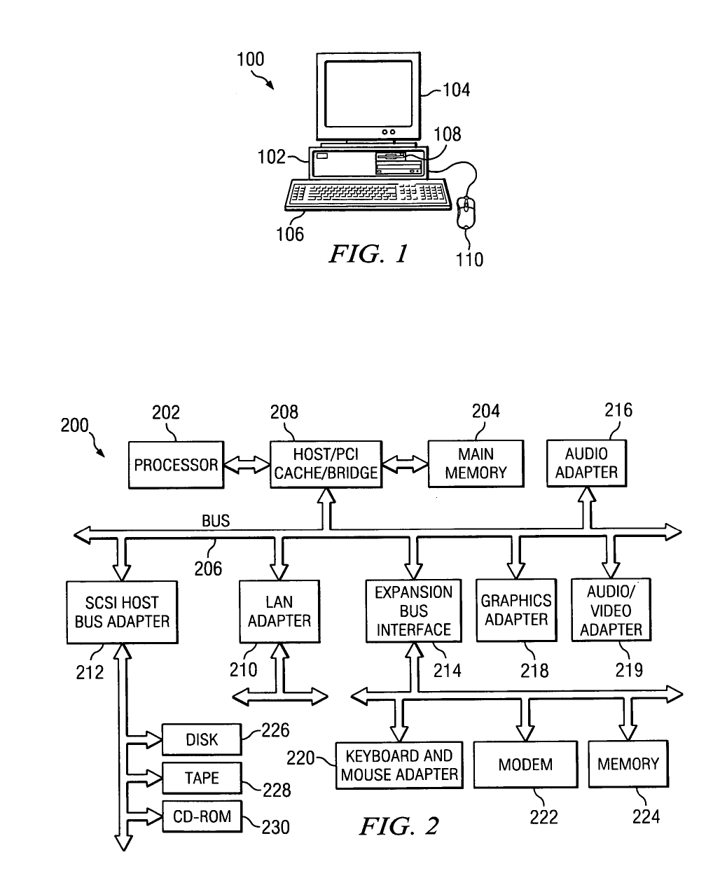

With reference now to the figures and in particular with reference to FIG. 1, a pictorial representation of a data processing system in which the present invention may be implemented is depicted in accordance with a preferred embodiment of the present invention. A computer 100 is depicted which includes system unit 102, video display terminal 104, keyboard 106, storage devices 108, which may include floppy drives and other types of permanent and removable storage media, and mouse 110. Additional input devices may be included with personal computer 100, such as, for example, a joystick, touchpad, touch screen, trackball, microphone, and the like. Computer 100 can be implemented using any suitable computer, such as an IBM eServer computer or IntelliStation computer, which are products of International Business Machines Corporation, located in Armonk, N.Y. Although the depicted representation shows a computer, other embodiments of the present invention may be implemented in other types of data processing systems, such as a network computer. Computer 100 also preferably includes a graphical user interface (GUI) that may be implemented by means of systems software residing in computer readable media in operation within computer 100.

With reference now to FIG. 2, a block diagram of a data processing system is shown in which the present invention may be implemented. Data processing system 200 is an example of a computer, such as computer 100 in FIG. 1, in which code or instructions implementing the processes of the present invention may be located. Data processing system 200 employs a peripheral component interconnect (PCI) local bus architecture. Although the depicted example employs a PCI bus, other bus architectures such as Accelerated Graphics Port (AGP) and Industry Standard Architecture (ISA) may be used. Processor 202 and main memory 204 are connected to PCI local bus 206 through PCI bridge 208. PCI bridge 208 also may include an integrated memory controller and cache memory for processor 202. Additional connections to PCI local bus 206 may be made through direct component interconnection or through add-in connectors. In the depicted example, local area network (LAN) adapter 210, small computer system interface (SCSI) host bus adapter 212, and expansion bus interface 214 are connected to PCI local bus 206 by direct component connection. In contrast, audio adapter 216, graphics adapter 218, and audio/video adapter 219 are connected to PCI local bus 206 by add-in boards inserted into expansion slots. Expansion bus interface 214 provides a connection for a keyboard and mouse adapter 220, modem 222, and additional memory 224. SCSI host bus adapter 212 provides a connection for hard disk drive 226, tape drive 228, and CD-ROM drive 230. Typical PCI local bus implementations will support three or four PCI expansion slots or add-in connectors.

An operating system runs on processor 202 and is used to coordinate and provide control of various components within data processing system 200 in FIG. 2. The operating system may be a commercially available operating system such as Windows XP, which is available from Microsoft Corporation. An object oriented programming system such as Java may run in conjunction with the operating system and provides calls to the operating system from Java programs or applications executing on data processing system 200. “Java” is a trademark of Sun Microsystems, Inc. Instructions for the operating system, the object-oriented programming system, and applications or programs are located on storage devices, such as hard disk drive 226, and may be loaded into main memory 204 for execution by processor 202.

Those of ordinary skill in the art will appreciate that the hardware in FIG. 2 may vary depending on the implementation. Other internal hardware or peripheral devices, such as flash read-only memory (ROM), equivalent nonvolatile memory, or optical disk drives and the like, may be used in addition to or in place of the hardware depicted in FIG. 2. Also, the processes of the present invention may be applied to a multiprocessor data processing system.

For example, data processing system 200, if optionally configured as a network computer, may not include SCSI host bus adapter 212, hard disk drive 226, tape drive 228, and CD-ROM 230. In that case, the computer, to be properly called a client computer, includes some type of network communication interface, such as LAN adapter 210, modem 222, or the like. As another example, data processing system 200 may be a stand-alone system configured to be bootable without relying on some type of network communication interface, whether or not data processing system 200 comprises some type of network communication interface. As a further example, data processing system 200 may be a personal digital assistant (PDA), which is configured with ROM and/or flash ROM to provide non-volatile memory for storing operating system files and/or user-generated data.

The depicted example in FIG. 2 and above-described examples are not meant to imply architectural limitations. For example, data processing system 200 also may be a notebook computer or hand held computer in addition to taking the form of a PDA. Data processing system 200 also may be a kiosk or a Web appliance.

The processes of the present invention are performed by processor 202 using computer implemented instructions, which may be located in a memory such as, for example, main memory 204, memory 224, or in one or more peripheral devices 226-230.

The present invention provides a mechanism for converting an integer to a floating point value using a data processing system such as data processing systems 100 and 200 illustrated in FIGS. 1 and 2. In many computer architectures, the process of converting an integer to a floating point value is quite slow and may have significant memory traffic. In accordance with the present invention, a method for converting an integer to a floating point value is provided that facilitates the conversion process such that conversion can often be performed more quickly and with less memory traffic than by conventional conversion procedures.

In accordance with a preferred embodiment of the present invention, a method for converting an integer to a floating point value is provided that utilizes data flow analysis and control flow analysis to determine if a given integer that is to be converted has a relatively limited range of known values (i.e., to determine if the value of the integer must be one of a relatively small range of possible values). An example of such an integer is an integer used to subscript an array whose bounds range from 0 to 10. In many languages, it would be invalid or undefined to index the array with a value outside this limited range; and data flow and control flow analysis can be used to determine that the integer must fall somewhere within a known range.

If it is determined that the value of an integer must fall somewhere within a limited range, a table of floating point values is built in memory that is initialized with each of the possible integer values. The table is then used to more efficiently convert the integer to a floating point value.

The invention can be better understood by the following example.

Consider a C sample program fragment as follows:

double xArray [10];

/* known bounds: lb (lower bound) = 0,
ub (upper bound) = 9*/

double realValue;
void p(int i) {

double value = xArray[i + 1];

/*i must be in the range −1 . . . 8*/

realValue = value + (double)i;

/*floating point conversion of value of i

*/

}

Data flow analysis reveals that at the point of conversion, i must have a value between −1 and 8 in order for this to be a valid C program. A compiler/optimizer of the data processing system will build a table of floating point values in memory initialized with the values of −1.0, 0.0, 1.0, 2.0 . . . up to 8.0:
const double table [10]={−1, 0, 1, 2, 3, 4, 5, 6, 7, 8};
   The conversion to float can then be replaced by the expression table [i+lb], where lb has the value 1 to handle the difference between the expected lower bound of −1 and the table (which is indexed starting with 0 in the language C).

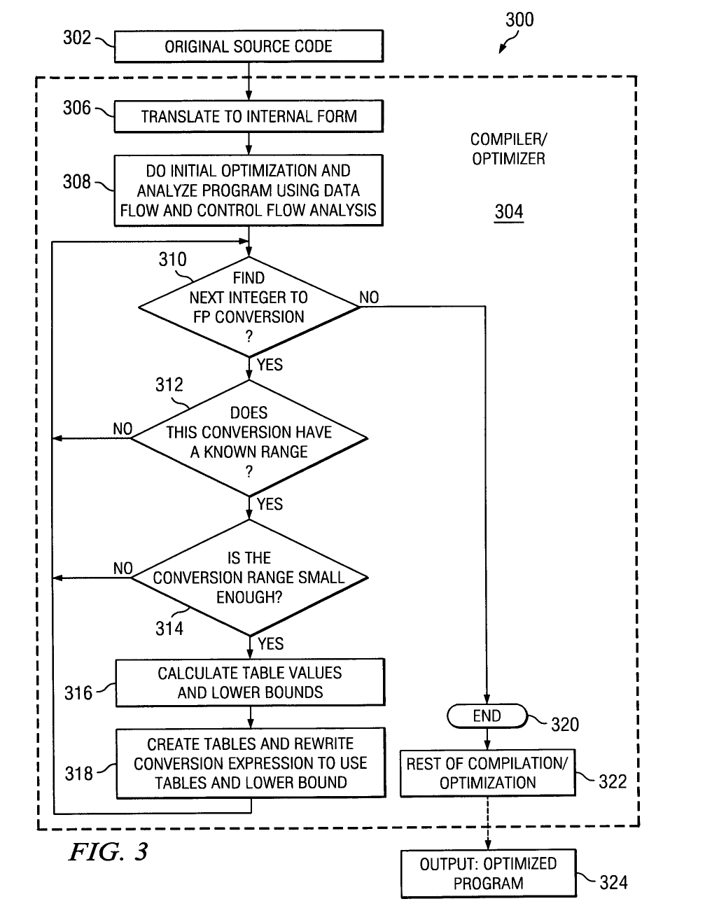

FIG. 3 is a flowchart that illustrates a method for converting integers to floating point values in accordance with a preferred embodiment of the present invention. The method is generally designated by reference number 300 and begins by providing an original source code (step 302) that is received by a compiler/optimizer, generally designated by reference number 304. Compiler/optimizer 304 translates the source code to an internal form (step 306), and then performs an initial optimization and analyzes the program using data flow analysis and control flow analysis (step 308).

A determination is then made if there is an integer that is to be converted to floating point value (step 310). If there is an integer to be converted to floating point value (Yes output of step 310), a determination is made whether the conversion to be performed has a known integer range using information computed during the initial optimization performed in step 308 or from the semantics of the programming language (step 312). If the conversion to be performed does not have a known range (No output of step 312), the method returns to step 310 to determine whether there is another integer to be converted to a floating point value. If the conversion to be performed has a known range (Yes output of step 312), a determination is made if the known range of integer values is “small enough” to permit efficient conversion (step 314). If the known range of integer values is not small enough to permit efficient conversion (No output of step 314), the method returns to step 310 to determine if there is another integer to be converted to a floating point value. If the range of integer values is small enough to permit efficient conversion (Yes output of step 314), the table values and lower bound are calculated (step 316), and a table is created and the conversion expression is rewritten to use the table and the lower bound of the integer range (step 318).

After the table is created and the conversion expression is rewritten to use the table and the lower bound of the integer range for the integer, the method returns to step 310 to determine if there is another integer to be converted to a floating point value. The method continues to cycle back to step 310 until it is determined that there are no more integers to be converted to floating point values (No output of Step 310), at which time the process of converting from integer to floating point value ends (step 320).

Following creation of a table and rewriting of the conversion expression to use the table and the lower bound of the integer range for each conversion in which the range of integer values is small enough to permit efficient conversion, the compilation/optimization process is then completed (step 322), and an optimized program is output from compiler/optimizer 304 (step 324).

The determination in step 314 of whether a known range of integer values is small enough to permit efficient conversion is made because if the integer range becomes too large, the table will also be very large; and if the table is very large, the advantages of reduced conversion time and reduced memory traffic provided by the present invention may be lost. In such circumstances, it may be preferable to convert the integer to a floating point value using conventional conversion techniques. In accordance with a preferred embodiment of the present invention, a “small enough” range of legal integer values to permit efficient conversion of an integer to a floating point value is, for example, a range that has up to about 256 possible values, thus allowing an integer stored in an 8-bit byte to be efficiently converted to floating point.

When practicing the conversion method illustrated in FIG. 3, if all floating point values to which an integer will be converted can be represented as float (4 byte floating point value), the floating point value should be so represented, as doing so will reduce the memory size of the table. Also, if there are multiple conversions from integer to floating point value within a compilation, it may be possible to combine (and possibly overlap) the multiple tables that are created, thus permitting a further reduction in memory size.

The present invention thus provides a method, system and computer program product for converting an integer to a floating point value in a data processing system. The method utilizes data flow analysis and control flow analysis to recognize that a particular integer that is to be converted contains only a limited range of values. Knowledge of this limited range is used to establish a table of floating point values indexed by the integer value. By using the table of floating point values, conversion of an integer to a floating point value can be performed faster and with reduced memory traffic.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for converting an integer to a floating point value, the method comprising:
providing a table of floating point values corresponding to a plurality of possible values for the integer; and
converting the integer to a floating point value using the table.

2. The method according to claim 1, further comprising:
determining the plurality of possible values for the integer prior to providing the table.

3. The method according to claim 2, wherein determining the plurality of possible values for the integer comprises:
determining the plurality of possible values for the integer using control flow analysis and data flow analysis.

4. The method according to claim 2, and further including:
deciding if the determined plurality of possible values for the integer is a small enough plurality of possible values for efficient conversion, wherein the table of floating point values is provided only if the determined plurality of possible values for the integer is small enough for efficient conversion.

5. The method according to claim 1, wherein providing a table of floating point values comprises:
calculating table values and a lower bound of the plurality of possible values for the integer; and
creating the table using the calculated table values and the calculated lower bound.

6. The method according to claim 1, wherein the table of floating point values is stored in memory.

7. A system for converting an integer to a floating point value in a data processing system, comprising:
a memory storing a table of floating point values corresponding to a plurality of possible values for the integer; and
a converter for converting the integer to a floating point value using the table.

8. The system according to claim 7, and further including a compiler/optimizer for determining the plurality of possible values for the integer.

9. The system according to claim 8, wherein the compiler/optimizer determines the plurality of possible values for the integer using control flow analysis and data flow analysis.

10. The system according to claim 7, wherein the data processing system includes a PowerPC architecture.

11. A computer program product in a computer readable medium for converting an integer to a floating point value, the computer program product comprising:
first instructions for providing a table of floating point values corresponding to a plurality of possible values for the integer; and
second instructions for converting the integer to a floating point value using the table.

12. The computer program product according to claim 11, and further including third instructions for determining the plurality of possible values for the integer prior to providing the table.

13. The computer program product according to claim 12, wherein the third instructions for determining the plurality of possible values for the integer comprises instructions for determining the plurality of possible values for the integer using control flow analysis and data flow analysis.

14. The computer program product according to claim 12, and further including fourth instructions for deciding if the determined plurality of possible values for the integer is a small enough plurality of possible values for efficient conversion, wherein the table of floating point values is provided only if the determined plurality of possible values for the integer is small enough for efficient conversion.

15. The computer program product according to claim 11, wherein the first instructions for providing a table of floating point values comprises:
fifth instructions for calculating table values and a lower bound of the plurality of possible values for the integer; and
sixth instructions for creating the table using the calculated table values and the calculated lower bound.
